(19) United States
(12) Patent Application Publication
(10) Pub. No.: US 2026/0296176 A1
(43) Pub. Date: Oct. 1, 2026

(54) TANK SYSTEM FOR A MOTOR VEHICLE, METHOD FOR OPERATING A TANK SYSTEM, MOTOR VEHICLE, COMPUTER PROGRAM PRODUCT, AND COMPUTER-READABLE MEDIUM

(71) Applicant: Robert Bosch GmbH, Stuttgart (DE)

(72) Inventors: Markus Strasser, Stuttgart (DE); Stefan Kieferle, Stuttgart (DE)

(21) Appl. No.: 19/480,998

(22) PCT Filed: Apr. 16, 2024
(86) PCT No.: PCT/EP2024/060224

§ 371 Date: Nov. 3, 2025

(30) Foreign Application Priority Data
May 10, 2023 (DE) 10 2023 204 291.6

(51) Int. Cl. B60K 15/01; B60K 15/03

(52) U.S. Cl. CPC B60K 15/013; B60K 15/03006; B60K 2015/03131; B60K 2015/03296; B60K 2015/03315

(57) ABSTRACT

A tank system (100) for a motor vehicle is proposed. The tank system (100) has a primary tank device (10), a secondary tank device (20), a primary filling path (31), a secondary filling path (32), a main filling path (33), a main distributor (30) and a tank path (34) for supplying the fluid to a fuel system (40) of the motor vehicle. The primary tank device (10) has at least one primary tank (12). The secondary tank device (20) has at least one secondary tank (22). The at least one primary tank (12) has a smaller tank volume than the at least one secondary tank (22). The primary filling path (31) has at least one throttle (35) and at least one first non-return valve (36) connected in parallel to each other. The at least one first non-return valve (36) is adapted to at least partially equalize the fluid pressure in the primary tank device (10) with the fluid pressure in the secondary tank device (20) in the event of a fault in the secondary tank device (20) and/or in the secondary filling path (32).

### BACKGROUND

The invention relates generally to the field of storage for fuels or gases. More specifically, the invention relates to a tank system for a motor vehicle, a method for operating such a tank system, a motor vehicle, a computer program product, and a computer-readable medium.

Tank systems for motor vehicles may comprise tanks or reservoirs having different storage volumes. For example, a tank system may comprise a main tank, or main reservoir, and one or more smaller tanks or reservoirs. Such a distribution of storage capacity for motor vehicles is particularly common with hydrogen tank systems.

If there are multiple tanks having different storage volumes, the line is usually throttled to fill the smaller tanks. This can ensure that different tanks of a tank system are filled evenly. Such a throttle is already in use with known tank systems.

The tanks of a tank system are typically equipped with a safety system, which, when a fault occurs, triggers to limit the mass flow out of the tanks. If a fault results in only a minor pressure drop in the line system, the safety system may not trip.

The provision of one or more throttles proves advantageous in an error-free operation, in particular for even filling of the tanks. However, if a fault occurs in one part of the tank system, the throttle may result in an insufficient pressure drop in another part of the tank system located on the other flow side of the throttle. This will not ensure that all safety systems of the tank system will trip when a fault occurs.

### SUMMARY

The tank system according to the invention for a motor vehicle with the features of the disclosure has the advantage that at least one throttle can nevertheless be provided for uniform filling of the tanks of the tank system, and yet the entire tank system for a motor vehicle can be operated safely.

The proposed tank system is therefore more reliable and safer than prior art tank systems. The proposed tank system reliably allows for safe and precise operation of the tank system for a motor vehicle.

Features, details and advantages described in connection with the tank system for a motor vehicle according to the invention clearly also apply in connection with the method for operating a tank system for a motor vehicle, motor vehicle, computer program product and/or computer-readable medium according to the invention, and vice versa, so that mutual reference to the individual considerations of the invention always is or can be made with respect to the disclosure.

A first aspect of the present disclosure relates to a tank system, in particular a gas tank system, for a motor vehicle. The tank system comprises a primary tank device, a secondary tank device, a primary filling path, which is adapted to supply fluid to the primary tank device, a secondary filling path which is adapted to supply fluid to the secondary tank device, a main filling path for supplying the fluid into the tank system, a main distributor connected to the primary filling path, the secondary filling path, and the main filling path, and a tank path for supplying the fluid from the primary tank device and/or from the secondary tank device to a fuel system of the motor vehicle. The primary tank device has at least one primary tank. The secondary tank device has at least one secondary tank. The at least one primary tank of the primary tank device has a smaller tank volume than the at least one secondary tank of the secondary tank device. The primary filling path has at least one throttle and at least one first non-return valve connected in parallel to each other in the primary filling path. The at least one first non-return valve is adapted to at least partially equalize the fluid pressure in the primary tank device with the fluid pressure in the secondary tank device in the event of a fault in the secondary tank device and/or in the secondary filling path.

In other words, the desired effect of the throttle in error-free operation of the tank system, which is disadvantageous in the event of a fault, can be bypassed in the event of a fault. A non-return valve is provided for this purpose, which can open automatically in the event of a fault in the secondary tank device, allowing the fluid flow to bypass the throttle. This means that in the event of a sudden line break, e.g. in an accident of the motor vehicle, in the area of the secondary fuel device, the throttle no longer throttles the total leakage from the primary tank device.

The tank system may be a fluid supply system for a fuel system of a motor vehicle, in particular a truck. The tank system may be a hydrogen tank system. The tank system may be a tank system for a fluid, such as a liquid fuel or a gaseous fuel. The tank system may comprise two or more tank devices. The tank device may differ in that it comprises one or more tank(s), wherein the tank(s) of a tank device have a different tank volume than the tank(s) of the other tank device.

The primary tank device and the secondary tank device each comprise at least one tank, i.e., a primary tank and a secondary tank. The tank may be a fluid reservoir or a container. The primary tank of the primary tank device may be coupled to a safety valve. A safety valve may be operatively coupled to the at least one primary tank of the primary tank device. Alternatively or additionally, a safety valve may be operatively coupled to the secondary tank of the secondary tank device. For example, the at least one primary tank has a storage capacity or tank volume of from 50 L to 150 L. For example, the at least one secondary tank has a storage capacity or tank volume of 300 L to 1000 L.

It should be noted that the primary filling path and the secondary filling path may not be limited to a direction of flow at least in sections. Rather, a filling path may comprise a plurality of lines. The primary filling path and/or the secondary filling path may each comprise at least two lines, i.e. via a relatively short section, wherein one line is adapted to direct the fluid into the respective tank and another line is adapted to direct the fluid out of the respective tank.

The primary filling path has a throttle. The throttle may be configured to fill the primary tank device, that is, the tank or tanks of the primary tank device, with a limited mass flow rate. As a result, the primary tank device and the secondary tank device may be uniformly filled during error-free operation of the tank system. In other words, the throttle on the primary filling path may ensures symmetrical fueling of the primary tank size and secondary tank, which are different sizes.

The fault may be a line break or line rupture in the secondary tank device, a leak in a line of the secondary tank device, and/or a line break in the secondary fill path. In such an error case, the fluid pressure in the lines of the secondary tank device may drop sharply. That is to say, in an error case, a fluid pressure drop may occur in the secondary tank device. The secondary tank device and the primary tank device may be adapted to close safety valves in response to such a pressure drop or pressure decrease. Due to the presence of the throttle in the primary filling path, when a fluid pressure drop in the secondary tank device occurs, the fluid pressure in the primary tank device, or in the lines of the primary tank device may remain the same or change only slightly, or decrease. It may therefore prove advantageous to bypass the throttle in the event of such a fault, i.e., a pressure drop in the secondary tank device, in order to also generate a pressure drop in the primary tank device.

For this purpose, at least one first non-return valve, which is connected in parallel with the throttle, can be provided in the primary filling path. The fluid flow towards the at least one secondary tank in the secondary filling path may thus bypass the throttle when a pressure drop occurs in the secondary tank device, and the first non-return valve may open, in particular due to the pressure drop in the secondary tank device. It follows that the fluid pressure in the primary tank device may at least partially equalize the fluid pressure in the secondary tank device. This has the advantage that in the event of a pressure drop in the secondary tank device, safety valves of the primary tank device may close, in particular automatically.

The operative orientation of the at least one first non-return valve is preferably such that, at a given opening pressure, the fluid from the primary tank device may flow through the at least one first non-return valve. The at least one first non-return valve may therefore be a spring loaded non-return valve.

Such a tank system can therefore be operated reliably and safely. In particular, by means of such a tank system, tanks can be filled in a reliable manner. Such a tank system can reduce the amount of leakage in the event of a fault by partially equalizing the fluid pressure in the primary tank device with the fluid pressure in the secondary tank device, such that, for example, a safe response or closure of a safety valve of the at least one primary tank may be assured.

It is advantageous for the primary tank device to have at least two primary tanks. In this case, the primary filling path for fluidly connecting the at least two primary tanks of the primary tank device comprises a primary distributor. In other words, the distributor may split the primary filling path, such that each of the at least two primary tanks may be filled with a branch of the filling path.

It is advantageous if the at least one throttle and the at least one first non-return valve of the primary filling path are disposed between the primary distributor and the main distributor. In other words, the throttle and the non-return valve may be disposed on the primary filling path in the direction of flow towards the tanks upstream of the primary distributor. This may prove particularly advantageous if the at least two primary tanks have the same tank volume.

It is advantageous if a throttle and the at least one first non-return valve are disposed between each of the at least two primary tanks of the primary tank device and the primary tank distributor. In other words, a throttle and a first non-return valve may each be disposed on a branch of the filling path. This may prove particularly advantageous if the at least two primary tanks of the primary tank device have different tank volumes.

According to an embodiment of the tank system, the at least two primary tanks of the primary tank device have different tank volumes.

It is advantageous for the primary filling path to have at least a second non-return valve oriented in the opposite direction to the at least one first non-return valve. The at least one second non-return valve is adapted to at least partially equalize the fluid pressure in the primary tank device with the fluid pressure in the secondary tank device in an event of a fault in the primary tank device and/or in the primary filling path. In other words, the throttle may be bypassed even if a fault occurs in the primary tank device. In the event of a fault in the primary tank device, a fluid pressure drop may occur in the primary tank device. In the event of a fluid pressure drop in the primary tank device, one or more safety valves of the primary tank(s) may automatically close. The secondary tank or tanks of the secondary tank device may also each be provided with a safety valve, which may close automatically in the event of a pressure drop. In order to automatically trigger a closure of safety valves in the secondary tank device in the event of a fault in the primary tank device, the pressure drop occurring in the primary tank device is to occur at least partially in the secondary tank device as well. This may be achieved by the at least one second non-return valve.

The at least one second non-return valve is preferably connected parallel to the throttle and to the at least one first non-return valve. The at least one second non-return valve may be a spring loaded non-return valve.

The direction of the corresponding second non-return valve may be the direction of action or flow. The direction of a non-return valve is generally indicative of the direction of flow in which the non-return valve can open at a given opening pressure.

It is advantageous if the at least one second non-return valve is adapted to open at a predefined increased opening pressure, particularly at a predefined opening pressure greater than the opening pressure of the at least one first non-return valve. This proves to be particularly advantageous because otherwise the throttle could also be bypassed in error-free operation of at least one second non-return valve. The predefined opening pressure of the at least one second non-return valve may be adjustable via a spring assembly.

A second aspect of the present disclosure relates to a method for operating a tank system for a motor vehicle as described above and below, particularly in the event of a fault, having the steps of:
supplying a fluid, in particular a gas, to the primary tank device and to the secondary tank device via the main filling path of the tank system,
supplying, in particular filling with, a predefined flow rate of the at least one secondary tank of the secondary tank device via the secondary filling path,
supplying, in particular filling, the at least one primary tank of the primary tank device via the primary filling path with the predefined flow rate using the throttle,
supplying the fluid from the primary tank device and/or from the secondary tank device to a fuel system of the motor vehicle via the tank path.

In the event of a fault in the secondary tank device and/or in the secondary fill path, the fluid pressure in the primary tank device is equalized at least in part with the fluid pressure in the secondary tank device by way of the at least one first non-return valve.

All advantages which have been explained in connection with the tank system according to the first aspect of the disclosure apply equally to the method according to the second aspect of the disclosure.

The fluid can preferably be hydrogen. The step of supplying the fluid to the primary tank device and to the secondary tank device may involve refueling a motor vehicle via the main filling path. The main distributor may distribute the fluid from the main filling path to the primary tank device and the secondary tank device.

It is noted that the at least one primary tank of the primary tank device may alternatively or additionally be filled with fluid, in particular gas, via the primary filling path using the pre-defined mass flow using the throttle. The at least one secondary tank of the secondary tank device may also alternatively or additionally be filled with a predefined mass flow with fluid, in particular with gas.

By supplying the fluid from the primary tank device and/or from the secondary tank device to a fuel system of the motor vehicle via the tank path, the fuel system of the motor vehicle may be operated. The fuel system may also have further components and/or control elements for a regulated or controlled supply of the fluid to the fuel system. The throttle may also serve to evenly drain the respective tanks when supplying the fluid from the primary tank device and/or from the secondary tank device. The fluid provided may be evenly withdrawn from the primary tank device and the secondary tank device.

In the event of a fault, that is, when a secondary tank device fault occurs, the fluid pressure in the primary tank device is at least partially equalized with the fluid pressure in the secondary tank device by the at least one first non-return valve. As a result, a pressure drop may also occur in the primary tank device. Pressure drops in a tank device, whether in the primary tank device and/or in the secondary tank device, may automatically trigger the closing of a safety valve. Advantageously, the at least one first non-return valve may at least partially transfer a pressure drop in the secondary tank device to the primary tank device. This may advantageously reduce the risk of greater leakage.

It is advantageous if, in the event of a fault in the secondary tank device and/or in the secondary filling path, the at least partial equalization of the fluid pressure in the primary tank device causes a safety valve of the at least one primary tank of the primary tank device to be actuated, which limits the mass flow from the at least one primary tank. Alternatively or additionally, it is contemplated that the flow rate from the at least one primary tank may be limited.

The safety valve may be a valve that is directly coupled to an opening of the corresponding tank, in particular operatively coupled. In other words, each tank of the tank system may be coupled to a safety valve.

It is advantageous in the event of a fault in the primary tank device and/or in the primary filling path if the fluid pressure in the secondary tank device is equalized at least in part with the fluid pressure in the primary tank device by way of the at least one second non-return valve.

It is advantageous if, in the event of a fault in the primary tank device and/or in the primary filling path, the at least partial equalization of the fluid pressure in the secondary tank device causes a safety valve of the at least one secondary tank of the secondary tank device to be actuated, which limits the mass flow out of the at least one secondary tank.

A third aspect of the present disclosure relates to a motor vehicle having a tank system as described above and below.

All advantages which have been explained in connection with the tank system according to the first aspect of the disclosure and/or with the method according to the second aspect of the disclosure apply equally to the motor vehicle according to the third aspect.

A fourth aspect of the present disclosure relates to a computer program product comprising instructions that, when executed by a control unit, prompt the control unit to perform a method, as described above and below.

A fifth aspect of the present disclosure relates to a computer readable medium having stored thereon the computer program product as described above.

### BRIEF DESCRIPTION OF THE DRAWINGS

In the following, exemplary embodiments of the invention are described with reference to the figures.

FIG. 1 schematically shows a tank system in accordance with an exemplary embodiment,

FIG. 2 schematically shows a tank system according to a further exemplary embodiment,

FIG. 3 schematically shows a tank system according to a further exemplary embodiment,

FIG. 4 schematically shows a tank system according to a further exemplary embodiment,

FIG. 5 schematically shows a tank system according to a further exemplary embodiment, and

FIG. 6 schematically shows a tank system according to a further exemplary embodiment,

### DETAILED DESCRIPTION

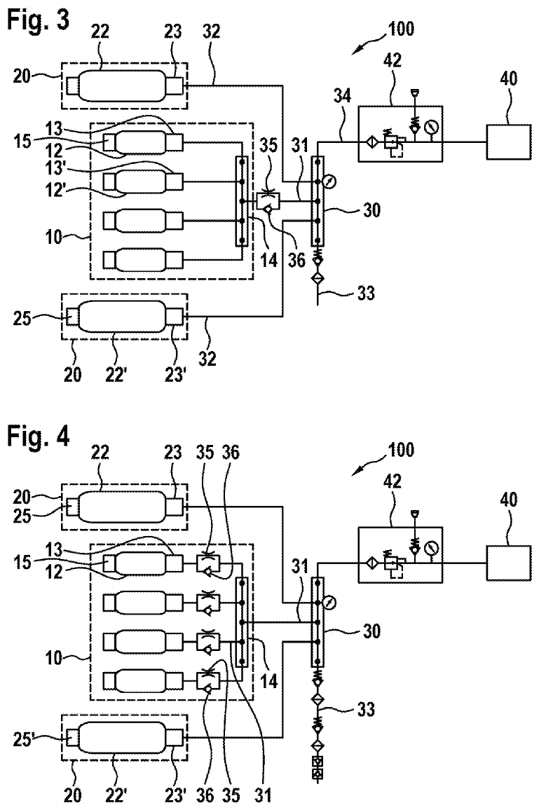

FIG. 1 schematically shows a tank system 100 in accordance with an exemplary embodiment, The tank system 100 of FIG. 1 may be part of a motor vehicle. The tank system comprises a primary tank device 10 and a secondary tank device 20. The primary tank device 10 comprises at least one primary tank 12, preferably at least two primary tanks 12, 12′. The primary tank device 10 of FIG. 1 has two primary tanks 12, 12′, therefore the tank system 100 with respect to FIG. 1 with two primary tanks 12, 12′ will be described below. The two primary tanks 12, 12′ of the primary tank device 10 may each be provided with a safety valve 13, 13′. The secondary tank device 20 comprises at least one secondary tank 22. The secondary tank 22 may also be equipped with a safety valve 23. The primary tank device 10 is fluidly communicatively connected to a main distributor 30 via a primary filling path 31. The secondary tank device 20 is fluidly communicatively connected to the main distributor 30 via a secondary filling path 32. The main distributor 30 is also fluidly communicatively connected to a main filling path 33 and to a tank path 34. The main filling path 33 can be used to fill the tank devices or tanks. The fluid may be provided to a fuel system 40 (see FIG. 3) via the tank path 34.

As the primary tank device 10 of the tank system 100 has two primary tanks 12, 12′, it may prove advantageous to provide a primary distributor 14. The primary distributor 14 may direct the fluid provided by the main distributor 30 to the two primary tanks 12, 12′. Between the two primary tanks 12, 12′ and the main distributor 30, the fluid may be directed by means of a primary filling path 31. Between the main distributor 30 and the secondary tank 22 of the secondary tank device 20, the fluid may be directed via a secondary loading path 32.

The primary filling path 31 has at least one throttle 35 and at least one first non-return valve 36, wherein the at least one throttle 35 and the at least one first non-return valve 36 are connected in parallel with each other. The throttle 35 is adapted to uniformly fill, that is, with a same predefined flow rate or mass flow, if the tank system 100, the two primary tanks 12, 12′ and the secondary tank 22 operate properly. As the tank system 100 of FIG. 1 has two primary tanks 12, 12′ with the same tank volume, the throttle 35 and the first check valve 36 can be arranged between the primary distributor 14 and the main distributor 30 on the primary filling path 31. This also means that only one throttle 35 and a single first non-return valve 36 can be provided.

Such a tank system 100 ensures that during a fueling operation, i.e., during a filling operation, the two primary tanks 12, 12′ may be refueled solely via the throttle 35. The throttle 35 may ensure that the two primary tanks 12, 12′ are uniformly filled with respect to the secondary tank 22.

In the event of a line breakage failure in the area of secondary tank 22, i.e., in the secondary tank device 20, the first non-return valve 36 may constitute a bypass to the throttle 35. Via the first non-return valve 36, the fluid pressure in the primary tank device 10 may be at least partially equalized with the fluid pressure in the secondary tank device 20. In the event of a line breakage, the fluid pressure in the secondary tank device 20 drops sharply. The first non-return valve 36 may therefore open due to the pressure drop in the secondary tank device 20 and the mass flow of the two primary tanks 12, 12′ may be discharged via a low pressure drop at the first non-return valve 36 for leakage in the primary tank device 10. Thus, a pressure drop may occur in the primary tank device 10. The pressure drop in the primary tank device 10 results in a differential pressure between the fluid pressure in the respective primary tanks 12, 12′ and the fluid pressure in the rest of the primary tank device 10. The differential pressure leads to activation of the safety valves 13, 13′ of the primary tanks 12, 12′. The respective safety valves 13, 13′ automatically close to limit the mass flow out of the two primary tanks 12, 12′. The safety valve 13, 13′ can be a so-called excess flow valve (EFV) or a drain protection unit. The first non-return valve 36 is preferably set such that even with minimum pressure drops, the first non-return valve 36 can open.

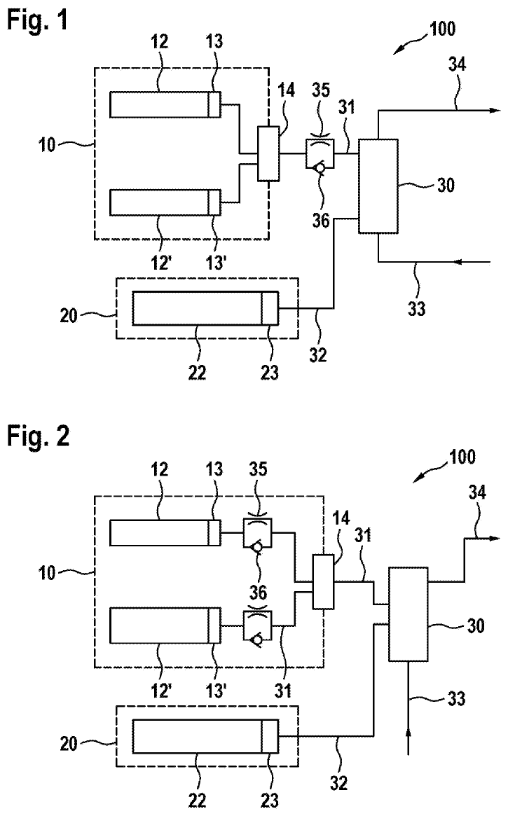

FIG. 2 shows a schematic tank system 100 in accordance with another embodiment. Unless otherwise described, the tank system 100 of FIG. 2 has the same elements and/or components as the tank system 100 of FIG. 1.

Unlike the tank system 100 of FIG. 1, the primary tank device 100 of FIG. 2 comprises two primary tanks 12, 12′ having different tank volumes. However, the principle of operation of the tank system 100 of FIG. 2 is comparable to the principle of operation of the tank system 100 of FIG. 1. However, a throttle 35 and a first non-return valve 36 are now provided per primary tank 12, 12′ of the primary tank device 10. In other words, the primary filling path 31 now includes two throttles 35 and two first non-return valves 36, wherein each are arranged at a branch of the primary filling path 31. A throttle 35 and a first non-return valve 36 are disposed between each of the two primary tanks 12, 12′ and the primary distributor 14. In so doing, the throttle 35 and the first non-return valve 36 are connected parallel to one another per branch of the primary filling path. In this way, it can be further ensured that all tanks 12, 12′, 22 of the tank system 100 can be equally filled and on the other hand, that in the event of a fault in the secondary tank device 20, the fluid pressure in the primary tank device 10, particularly in each path or line of the primary tank device 10, can be at least partially equalized with the fluid pressure in the secondary tank device 20.

It may be noted that such an arrangement of the two throttles 35 and the two first non-return valves 36 may also be provided when the two primary tanks 12, 12′ of the primary tank device 10 have the same tank volume.

FIGS. 3 and 4 show a schematic tank system 100 according to further exemplary embodiments. Unless otherwise described, the tank systems 100 of FIGS. 3 and 4 each have the same elements and/or components as the tank systems 100 of FIGS. 1 and 2. FIG. 3 may be considered an analogous embodiment to FIG. 1. FIG. 4 may be considered an analogous embodiment to FIG. 2. Unlike FIGS. 1 and 2, the tank systems 100 of FIGS. 3 and 4 have four primary tanks 12. All four primary tanks 12 are provided with a safety valve 13. The secondary tank devices 20 of the tank systems 100 of FIGS. 3 and 4 each have two secondary tanks 22. Each secondary tank 22, 22′ is provided with a safety valve 23, 23′.

In an automotive vehicle, the primary tanks 12, 12′ may be disposed substantially centrally relative to the width of the automotive vehicle. The secondary tanks 22, 22′ may be laterally disposed in the motor vehicle. Preferably, a secondary tank 22 is arranged on each side of the motor vehicle. The primary and secondary tanks 12, 22 can be arranged symmetrically in the motor vehicle.

Primary tanks 12, 12′ may each be equipped with a temperature sensor and/or a pressure sensor. Also, the secondary tanks 22, 22′ may each be equipped with a temperature sensor and/or a pressure sensor. The main filling path 33 may include controls and/or sensors configured to set a predetermined fluid pressure. The main filling path 33 may further comprise a non-return valve or filter. A further non-return valve may be disposed on the main filling path 33 for safety reasons. The tank path 34 is fluidly communicatively connected to the fuel system 40 of the motor vehicle. A pressure regulator unit 42 is preferably provided on the tank path 34, which in particular has a pressure regulator, a medium pressure sensor and/or a pressure relief valve. Such a pressure regulator unit 42 allows the fuel system 40 to be supplied with fluid in a better and more reliable manner. The main distributor 30 may be connected to a high-pressure sensor.

The primary tanks 12, 12′ and the secondary tanks 22, 22′ of the respective tank devices may also be embodied with an end plug 15, 25 with additional safety means. The safety devices in the end plug 15, 25 are preferably temperature-controlled.

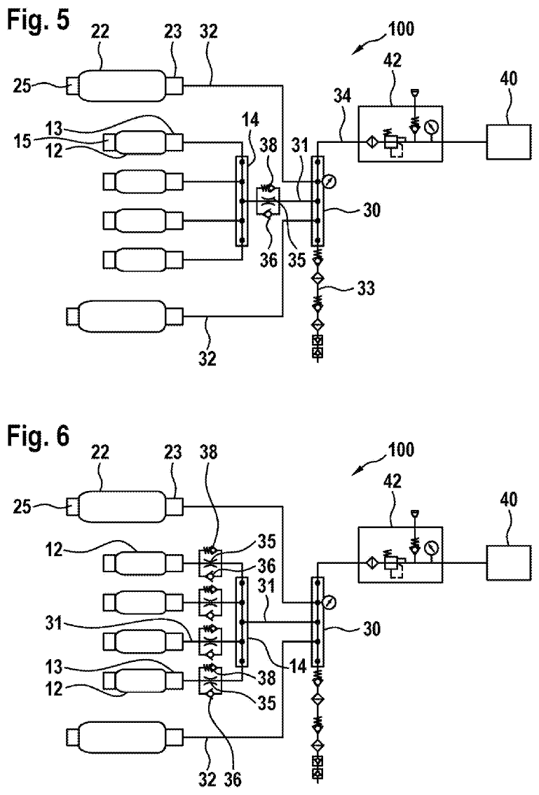

FIG. 5 shows a schematic tank system 100 in accordance with another embodiment. Unless otherwise described, the tank system 100 of FIG. 5 has the same elements and/or components as the tank system 100 of FIG. 1 to 4. The primary filling path 31 of the tank system 100 of FIG. 5 further comprises a second non-return valve 38 oriented in the opposite direction to the at least one first non-return valve 36. The second non-return valve 38 is adapted to at least partially equalize the fluid pressure in the primary tank device 10 with the fluid pressure in the secondary tank device 20 in an event of failure in the primary tank device 10 and/or in the primary filling path 31. The at least one second non-return valve 38 is preferably connected in parallel to the throttle 35 and to the first non-return valve 36 at the primary filling path 31. In other words, a further non-return valve 38 is provided, which can open at increased opening pressure and acts in the opposite direction to the at least one first non-return valve. The additional second non-return valve 38 with increased opening pressure allows the outflowing quantity from the secondary tanks 22, 22′ to be discharged into the area of the primary tank device 10 via the second check valve 38 with limited pressure drop, even in the event of a line break in the area of the primary tank device 10. This solution may be suitable for tank systems 100 in which, in the described event of a fault, there is a risk that the safety valves 23, 23′ of the secondary tanks 22, 22′ will not close due to a lack of differential pressure to the internal tank pressure. This risk increases with an increasing number of secondary tanks 22, 22′.

The opening pressure of the at least one second non-return valve 38 is preferably selected to be so high that it is just above the maximum expected differential pressure on the throttle during filling of the tank devices 10, 20 and/or fueling, in particular in error-free operation. Thus, the necessary throttling for uniform filling may still be provided when filling the tank devices 10, 20.

FIG. 6 schematically illustrates a tank system 100 in accordance with another embodiment. Unless otherwise described, the tank system 100 of FIG. 6 has the same elements and/or components as the tank system 100 of FIGS. 1-5, in particular as the tank system 100 of FIG. 4. The principle of operation of the tank system 100 of FIG. 6 is comparable to the principle of operation of the tank systems of FIGS. 2 and 4. At each branch off of the primary filling path 31, a throttle 35, a first non-return valve 36, and a second non-return valve 38 are disposed between the respective primary tank 12 and the primary distributor 14, wherein the throttles 35, the first non-return valve 36 and the second non-return valve 38 are connected in parallel with each other. Such an exemplary embodiment may prove advantageous, in particular for primary tanks 12, 12′ of different sizes.

Similar, similarly acting, identical or identically acting elements are provided with similar or the same reference numbers in the figures. The figures are merely schematic and are not to scale.

1. A tank system (100) for a motor vehicle, the tank system (100) comprising:
a primary tank device (10),
a secondary tank device (20),
a primary filling path (31), which is adapted to supply fluid to the primary tank device (10),
a secondary filling path (32), which is adapted to supply fluid to the secondary tank device (20), and
a main filling path (33) for supplying the fluid into the tank system (100),
a main distributor (30) connected to the primary filling path (31), the secondary filling path (32) and the main filling path (33) and a tank path (34) for supplying the fluid from the primary tank device (10) and/or from the secondary tank device (20) to a fuel system of the motor vehicle,
wherein the primary tank device (10) has a primary tank (12, 12′) and the secondary tank device (20) has a secondary tank (22),
wherein the primary tank (12, 12′) of the primary tank device (10) has a smaller tank volume than the secondary tank (22) of the secondary tank device (20),
wherein the primary filling path (31) has a throttle (35) and a first non-return valve (36) connected in parallel to each other in the primary filling path (31),
wherein the first non-return valve (36) is adapted to at least partially equalize a fluid pressure in the primary tank device (10) with the fluid pressure in the secondary tank device (20) in the event of a fault in the secondary tank device (20) and/or in the secondary filling path (32).

2. The tank system (100) according to claim 1,
wherein
the primary tank device (10) has at least two primary tanks (12, 12′), wherein the primary filling path (31) has a primary distributor (14) for fluid connection of the at least two primary tanks of the primary tank device (10).

3. The tank system (100) according to claim 2,
wherein
the throttle (35) and the first non-return valve (36) of the primary filling path (31) are disposed between the primary distributor (14) and the main distributor (30).

4. The tank system (100) according to claim 1,
wherein
a throttle and the first non-return valve (36) are disposed between each of the two primary tanks (12, 12′) of the primary tank device (10) and the primary tank distributor (14).

5. The tank system (100) according to claim 2,
wherein
the two primary tanks (12, 12′) of the primary tank device (10) have different tank volumes.

6. The tank system (100) according to claim 1,
wherein
the primary filling path (31) has a second non-return valve (38) oriented in an opposite direction to the first non-return valve (36),
wherein the second non-return valve (38) is adapted to at least partially equalize the fluid pressure in the secondary tank device (20) with the fluid pressure in the primary tank device (10) in the event of a fault in the primary tank device (10) and/or in the primary filling path (31).

7. The tank system (100) according to claim 6,
wherein
the second return valve (38) is adapted to open at a predefined increased opening pressure, at a predefined opening pressure greater than the opening pressure of the first non-return valve (36).

8. A method for operating a tank system for a motor vehicle according to claim 1, of the method comprising:
supplying a fluid to the primary tank device (10) and to the secondary tank device (20) via the main filling path (33) of the tank system (100),
supplying with a predefined flow rate of the secondary tank (22) of the secondary tank device (20) via the secondary filling path (32),
supplying the primary tank (12, 12′) of the primary tank device (10) via the primary filling path (31) with the predefined flow rate using the throttle (35), and
supplying the fluid from the primary tank device (10) and/or from the secondary tank device (20) to a fuel system of the motor vehicle via the tank path (34),
wherein, in the event of a fault in the secondary tank device (20) and/or in the secondary filling path (32), the fluid pressure in the primary tank device (10) is at least partially equalized with the fluid pressure in the secondary tank device (20) by the first non-return valve (36).

9. The method according to claim 8,
wherein
in the event of a fault in the secondary tank device (20) and/or in the secondary filling path (32), a safety valve (13, 13′) of the primary tank (12, 12′) of the primary tank device (10) is actuated by at least partially equalizing the fluid pressure in the primary tank device (10), which limits a mass flow from the primary tank (12).

10. The method according to claim 8,
wherein
in the event of a fault in the primary tank device (10) and/or in the primary filling path (31), the fluid pressure in the secondary tank device (20) is equalized with the fluid pressure in the primary tank device (10) at least partially by means of a second non-return valve (38).

11. The method according to claim 10,
wherein
in the event of a fault in the primary tank device (10) and/or in primary secondary filling path (31), a safety valve (23) of the secondary tank (22) of the secondary tank device (20) is actuated by at least partially equalizing the fluid pressure in the secondary tank device (20), which limits a mass flow from the secondary tank (22).

12. A motor vehicle having a tank system (100) according to claim 1.

13. (canceled)

14. A non-transitory, computer-readable medium comprising instructions which when executed by a computer cause the computer to control a tank system (100) for a motor vehicle by controlling
supply of a fluid to a primary tank device (10) and to a secondary tank device (20) via a main filling path (33) of the tank system (100),
a predefined flow rate of the secondary tank (22) of the secondary tank device (20) via a secondary filling path (32),
supply of a primary tank (12, 12′) of a primary tank device (10) via the primary filling path (31) with the predefined flow rate using a throttle (35), and
supply of a fluid from the primary tank device (10) and/or from the secondary tank device (20) to a fuel system of the motor vehicle via a tank path (34),
wherein, in the event of a fault in the secondary tank device (20) and/or in the secondary filling path (32), a fluid pressure in the primary tank device (10) is at least partially equalized with a fluid pressure in the secondary tank device (20) a first non-return valve (36).
